(19) United States
(12) Patent Application Publication
(10) Pub. No.: US 2007/0060368 A1
(43) Pub. Date: Mar. 15, 2007

(54) Synergistic on-line game system

(76) Inventor: Hung-Lin Cheng, Nantou County (TW)

Correspondence Address: THE MAXHAM FIRM, 9330 SCRANTON ROAD, SUITE 350, SAN DIEGO, CA, 92121, US

(21) Appl. No.: 11/339,910

(22) Filed: Jan. 25, 2006

(30) Foreign Application Priority Data
Aug. 12, 2005 (TW) 09 41276 24

(51) Int. Cl. A63F 9/24; G06F 19/00

(52) U.S. Cl. 463/42

(57) ABSTRACT

The present invention provides a synergistic on-line game system. After the user logins the on-line game platform of the provider, the characteristics of a virtual character would be set up to begin its virtual life. Even the user logouts, such virtual would still go on continuously. Moreover, the virtual commodities in the virtual world would emulate their substantial correspondents in real world to achieve the purpose of advertisement and built-in marketing. The gift service is further provided to the user to buy certain gifts on-line to give to other anonymous users. Besides, the user could also apply the shopping platform to buy the correspondents of the virtual commodities.

### FIELD OF THE INVENTION

The present invention is related to a synergistic on-line game, particularly to an on-line game and business method which incorporates shopping mechanism as well as provides service of presenting a gift.

### Background of the Invention

The on-line game becomes prevalent with the popularity of broadband network. Hundreds of kinds of game are available in the market. However, in order to strengthen the character, some game users may utilize certain tricky program to let the character remain in the virtual space, even after they logout. In this way, the value of experience of such character could keep increasing all the time. This circumstance is quite unfair, so the on-line game service provider naturally has the duty to solve the problem.

While playing the on-line game, the users could also exchange messages or even talk with each other, and therefore the social contacts are remarkably extended. Generally, most female users access Internet merely for collecting information and shopping. Hence, the population of female on-line game users is significantly less than that of the male on-line game users. There is huge effort could be put to open up the female on-line game market.

Moreover, since the world of network is virtual and anonymous, only few users would like reveal actual personal information. In the case of on-line game, the service provider is generally the only one who could access the personal information of the users. Consequently, except the message, no other anonymous way for interaction or communication is provided. As certain special days come, one thus could not present the gift to a friend in the virtual space.

Therefore, the present invention hereby provides a synergic on-line game and business method to solve the aforementioned problems as well as eliminate the inconvenience.

### SUMMARY OF THE INVENTION

The main purpose of the present invention is providing a synergistic on-line game, which is built based on a synergistic cooperation model with the ability of increasing the users' identification with game and achieve the goal of advertising and marketing.

Another purpose of the present invention is providing a synergistic on-line game, which is built based on a fair and transmigration mechanism. All characters would grow up in the same pace, and the “life” of every character continues even after the user logouts. Thus, the unfair situation that the strength of character mainly depends on the login duration of the user could be eliminated.

Still another purpose of the present invention is providing a synergistic on-line game, which builds up a convenient and user-friendly gift mechanism. Besides interacting with other users, the user could buy a physical gift to certain user via the game service provider.

Yet another purpose of the present invention is providing a synergistic on-line game, which builds up a synergistic shopping platform. Besides playing the on-line game, the user could also enter the shopping platform to buy the physical product corresponding to certain commodities in the virtual space.

In order to achieve above purposes, after the user logins the game platform, certain features of the character may be set to proceed with a virtual life. The life of the character would go on as the user logouts, and therefore the tricky program would become useless. Various brands of the real world could be placed in the virtual space for advertising and marketing, namely most commodities in the virtual space is marked with some brands to increase the users' identification with the game. In addition, the gift service is provided to the user for presenting a gift to certain user. The shopping platform is provided for the user to buy physical goods corresponding with certain commodities in the virtual space, and therefore more female users might be attracted.

The on-line game system of the present invention includes: a bus; a processor coupled to the bus, for processing an instruction; a network device coupled to the bus, for accessing a network; and a storage medium coupled to the bus, for storing a management module, a game module and a shopping module. The management module enables a first user to login through the network, and the game module provides on-line game service. Moreover, the shopping module provides on-line shopping service in a virtual space. With the on-line game system, the first user may play the on-line game and present a gift to an appointed person by manipulating a first virtual character in the virtual space. After that, the gift would be delivered to the appointed person after a gift instruction is received by the shopping module and then transmitted to a logistics system by the management module transmits.

The method for on-line shopping of the present invention comprises following steps: providing an on-line game system for a first user to login, wherein a virtual space is formed by the on-line game system, and the user plays the on-line game by manipulating a first character in the virtual space; providing a shopping mechanism for the first to buy an article, wherein a virtual commodity in said virtual space emulates the article; and informing a logistics system to deliver the article to a receiver appointed by the first user.

### BRIEF DESCRIPTION OF THE DRAWINGS

FIG. 1 is the diagram of the mechanism of the synergistic on-line game as well as the synergistic business model according to the present invention.

FIG. 2 is an on-line game system diagram according to one preferred embodiment of the present invention.

FIG. 3 is a flow chart according to one preferred embodiment of the present invention.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

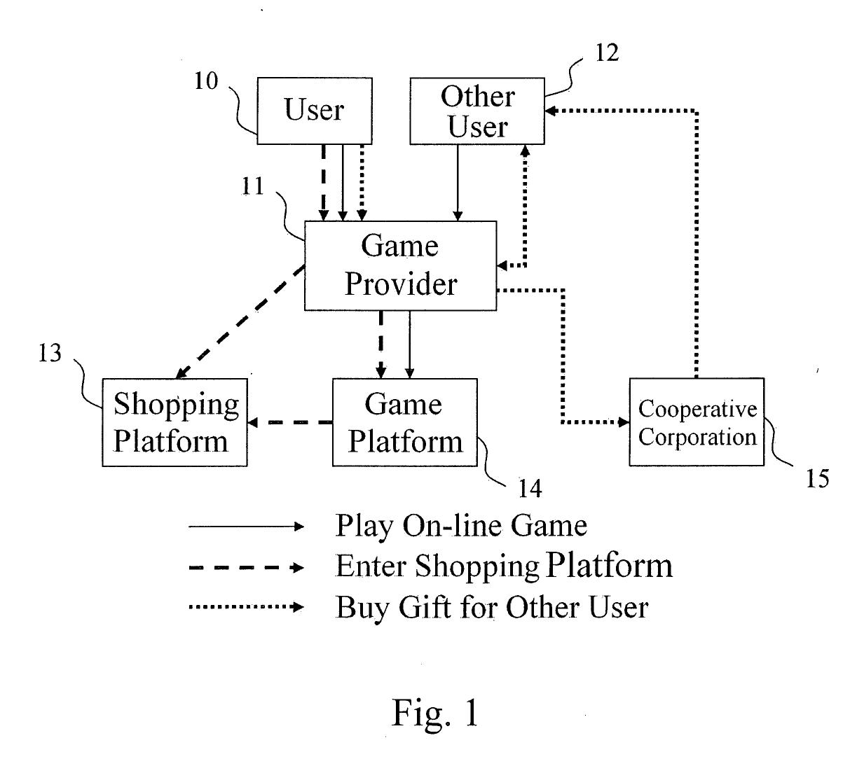

Please refer to FIG. 1, which illustrates the mechanism of the synergistic on-line game as well as the synergistic business model according to the present invention. After the user 10 logins the on-line service provider 11, a game platform 13 could be coupled and utilized to determine the features of the virtual character created in a game module, and a virtual life would then be initiated. Since the above method or operation for logining the on-line game is well-known, the details thereof are omitted to avoid obscuring the present invention. The character (virtual character) may receive the training program set by the user 10, and a visualized arranging system could be provided to facilitate the arrangement of the training programs. In view of the disadvantage that the strength of the character would increase mainly depending on the login duration, the elapsing of time is preferably continuous and automatic. That is, whether the user 10 logins the game server or not, the virtual life of the character will still go on. Hence, the user 10 should preset the schedule of the character to prevent certain accident, such as starvation. If the accident does happen, the game service provider would notify the user 10 by means of the Internet messenger, the telephone, the cellular phone or the e-mail. Besides, the game of the present invention possesses the characteristics of transmigration. As the character passes away, her/his property and experience values could be inherited by another virtual character.

Moreover, the game service provider 11 places the advertisements or articles with various certain brands in the virtual space built by the game. These articles may be applied as the stage property or commodities in the game to increase the user's identification and improve the benefit of the commercial. In addition, the Avatar model could be applied to enable the user 10 to buy various commodities to dress up her/his character. For example, the commodities in the store of the on-line game would show the pictures of the physical article with certain brands, such as Sony™ or LV™. Also, the user 10 could buy the clothes of Chanel™ for her/his character to fulfill the fantasy of herself/himself. More important, in the virtual space, the user 10 may find some favorite goods, and she/he would like to buy the physical correspondents in the real world. To satisfy this demand, the present invention further provides a shopping platform 13 for the user 10 to buy the physical goods corresponding to the virtual commodities. For example, a button may be provided to switch to the shopping platform 13 promptly, without further logining. Furthermore, the user 10 could also enter the shopping platform 13 directly after logining the game service provider 11.

In the game platform 14, the user 10 could chat or exchange messages with other user 12 while playing the on-line game, via Internet. For the anonymity of Internet, no one could access the information of other users from the game service provider 11. Accordingly, it is quite difficult to present the gift to other user while keeping anonymous. In order to solve such problem, the game service provider 11 therefore provides the gift service to enable the user 10 to present the gift to other user through the game service provider 11. The user 10 merely has to tell the provider 11 about the account (character) of the appointed user 12 and select certain gift, and then the provider 11 would ask the appointed user 12 whether receiving the gift or not. At the same time, the validity of the instruction or information would be confirmed. If the appointed user 12 agrees, the user 10 would be charged for the gift service, by means of a credit card, the money remittance or game points. The provider 11 then would instruct the cooperative cooperation (logistics system) 15, by means of telephone, facsimile or E-mail, to prepare the gift and deliver it to the appointed user 12. During whole process, only the service provider 11 and the cooperative operation could access the information of the users 10 and 12, so the privacy would be properly protected.

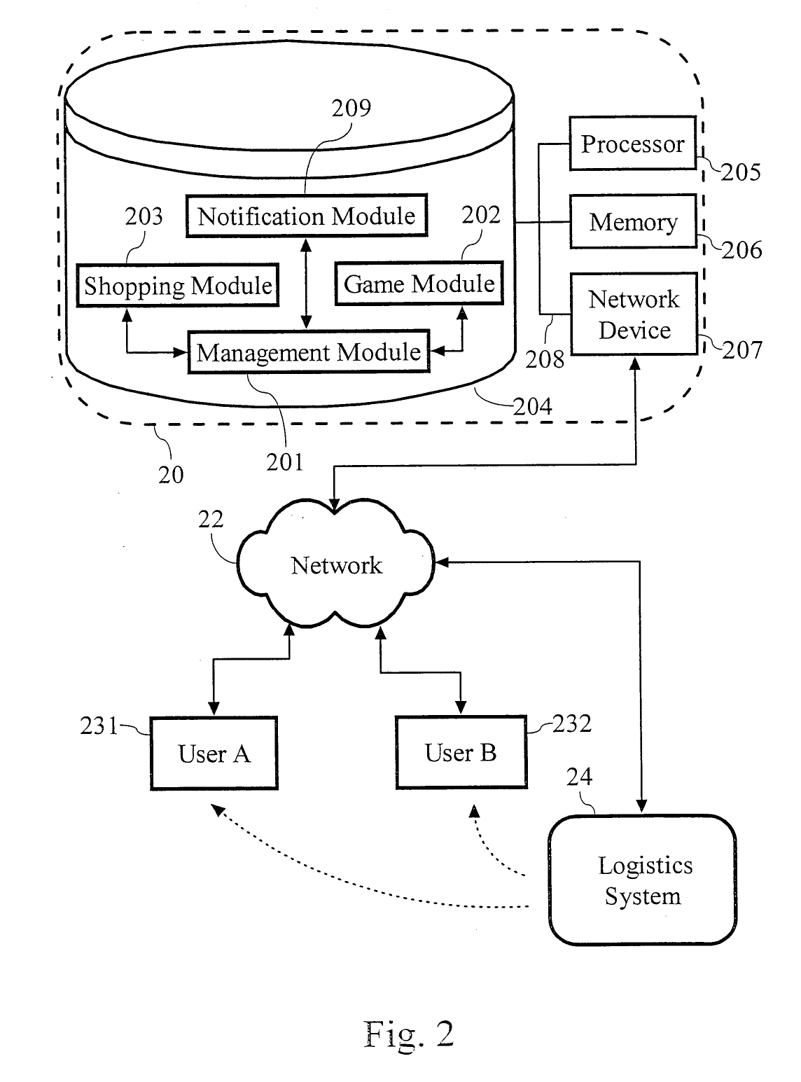

Please refer to FIG. 2, which illustrates an on-line game system diagram according to one preferred embodiment of the present invention. The on-line game system comprises a processor 205, memory 206, a network device 207 and a storage medium 204. All the elements are connected or coupled by the bus 208 for exchanging signals or information. Some function modules are stored in the storage medium 204 and executed by the processor 205. These modules include management module 201, game module 202 and shopping module 203, which cooperate together to achieve various effects or results of the present invention. Besides, the management module 201 is coupled to the shopping module 203 and game module 202, respectively. Although the elements in FIG. 2 are linked by wired lines, the present invention should encompass all other possible ways of connection or coupling, such as wireless communication.

In addition, the storage medium 204 may be a hard disc, a compact disc (CD), a digital versatile disc (DVD), flash memory, a floppy disc or other medium capable of maintaining digital information. The memory 206 of the system 20 is applied as the cache for temporarily keeping the data. In another embodiment of the present invention, the memory 206 could be replaced or omitted if the transmission rate of storage medium 204 is fast enough. Since the network device 207 is mainly utilized for accessing Internet, any suitable device with the ability of accessing network, such as the network adaptor, the modem or the Bluetooth™ device, would be included in the present invention.

Furthermore, each functional module is presented by individual block, but it is possible to have a single module capable of all desired functions in another embodiment. As well, in still another embodiment, several sub-modules could cooperate to achieve certain function which is originally achieved by single module. The ways of illustration in figures are convenient for explanation, instead of limitation.

In the system architecture of the preferred embodiment, the user A 231 and user B 232 could login the management module 201 of the on-line game system 20 through network 22 to play the on-line game provided by the game module 202. In this embodiment, users play the on-line game by manipulating the character in the virtual space built by the game module 202. The detail procedure thereof is described above and therefore omitted herein. Moreover, the user could also directly shop in the shopping platform provided by the sopping module 203, as well as buy the gift for other users.

It should be appreciated that two users are presented in FIG. 2, but it does not imply that only two users are allowed to login the system. The number of on-line users generally depends on the capability of individual server or the network bandwidth, and the present invention should encompass every possible number of on-line users.

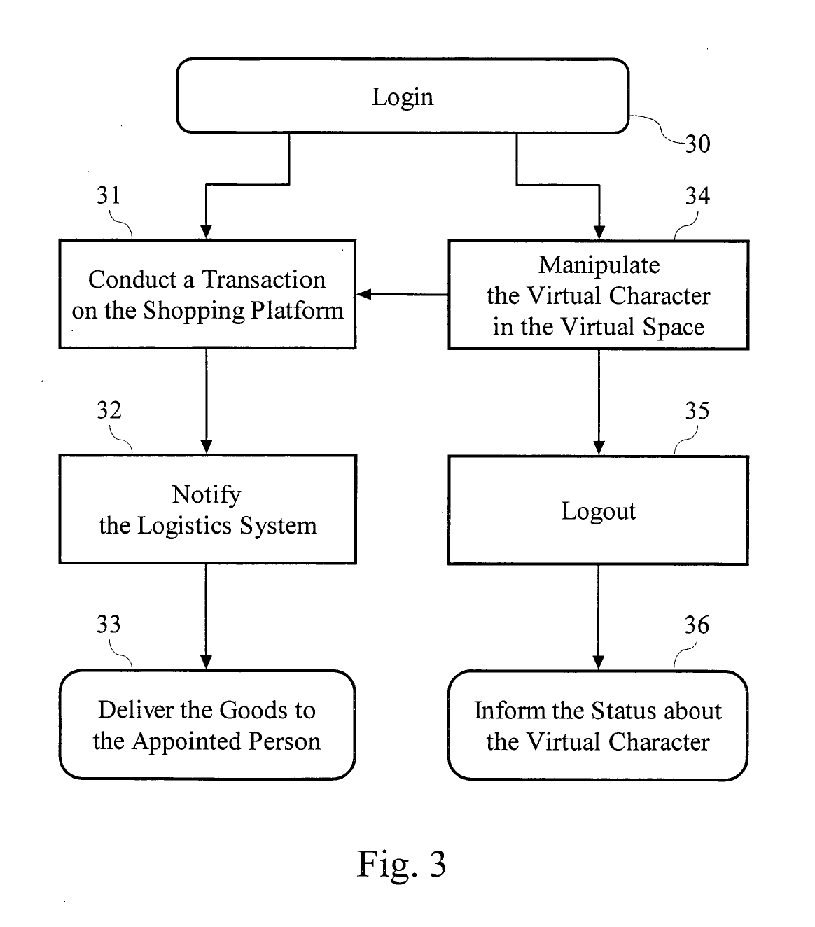

Please refer to FIG. 3 concurrently. The user A 231 logins the management module 231 of the game system 20 in step 30. If the user A 231 would like shop or present the gift, she/he may directly login the shopping platform provided by the game module 203, as shown in step 31. As the user A 231 buys certain article and appoints a receiver, namely user B 232, the account or character of this receiver is required to be provided to the system 20. In this embodiment, user A 231 and user B 232 know each other in the virtual space built by the game module 202, and they only realize which character manipulated by certain user is. Accordingly, if one wants to give the gift to another, the system 20 needs to provide related information about the receiver to the cooperative logistics system 24. In this way, the privacy as well as anonymity would be well protected. Besides, the logistics system 24 needs not to know which account or character is owned by the receiver, neither who is the giver.

The logistics system 24 will deliver the gift or article to the user B 232 right after receiving the instruction, as shown in step 33. In this embodiment, the system 20 could only inform the user B 232 that the giver is “character A” without the information of the owner, user A 231.

In another embodiment of the present invention, the user B 232 logins the system 20 in step 30, and plays the on-line game by manipulating the character B in step 34. Since some virtual commodities in the virtual space emulate the physical goods in the real world to achieve the purpose of advertising or marketing, the user B 232 could buy the correspondents of the virtual commodities, namely the physical goods, in the virtual space. The details of the purchasing procedure are similar with the description of steps 31 to 33, and therefore are omitted herein for avoiding redundancy.

After the user B 232 logouts, the manipulated character B would still continue her/his “life” in the virtual space according to the preset schedule. In other words, the elapsing of time would not stop all the time. Consequently, the system 20 preferably keeps monitoring the status of the character B, and the notification module 209 notifies the user B 232 immediately by means of the e-mail, the telephone, the Internet phone or the message, if certain incident occurs.

In conclusion, the present invention provides an on-line game including virtual life. By applying the mechanism of nonstop time elapsing, the defect of tricky program inducing unfair competition would be effectively avoided. Besides, with the synergic business model, various brands in the real world could be placed in the virtual space to attract the users, especially the female users, to buy goods in the shopping platform. In addition, the gift service could also bring more interaction between the users.

As is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. An on-line game system, which includes:
a bus;
a processor coupled to said bus, for processing an instruction;
a network device coupled to said bus, for accessing a network; and
a storage medium coupled to said bus, for storing a management module, a game module and a shopping module, wherein said management module enables a first user to login through said network, said game module provides on-line game service, and said shopping module provides on-line shopping service in a virtual space, a first virtual character being created in said game module;
wherein said first user presents a gift during the play of said on-line game to an appointed person by manipulating said first virtual character in said virtual space, and said gift is delivered to said person after a gift instruction is received by said shopping module and then transmitted to a logistics system by said management module transmits.

2. The on-line game system as set forth in claim 1, wherein said first user appoints a second virtual character created in said game module in said virtual space, and said second virtual character is manipulated by a second user.

3. The on-line game system as set forth in claim 1, wherein said logistics system is independent from said on-line game system.

4. The on-line game system as set forth in claim 1, wherein said gift includes a virtual commodity emulating a real article.

5. The on-line game system as set forth in claim 1, wherein time of said virtual space elapses continuously, and said first character keeps living in said virtual space after said first user logouts.

6. The on-line game system as set forth in claim 1, wherein a notification module storing in said storage medium notifies said user as predetermined incidents occur by means of an e-mail, a mobile phone, a telephone or a Internet phone.

7. The on-line game system as set forth in claim 1, wherein said user pays by a credit card, money remittance or game points.

8. The on-line game system as set forth in claim 1, wherein all properties or experience values of said first user is inherited by a third character appointed by said first user as said first character passes away in said virtual space.

9. A method for on-line shopping, comprises:
providing an on-line game system for a first user to login, wherein a virtual space is formed by said on-line game system, and said user plays said on-line game by manipulating a first character in said virtual space;
providing a shopping mechanism for said first user to buy an article, wherein a virtual commodity in said virtual space emulates said article; and
informing a logistics system to deliver said article to a receiver appointed by said first user.

10. The method as set forth in claim 9, wherein said first user appoints a second virtual character in said virtual space as said receiver, and said second virtual character is manipulated by a second user.

11. The method as set forth in claim 9, wherein time of said virtual space elapses continuously, and said first character keeps living in said virtual space after said first user logouts.

12. The method as set forth in claim 9, wherein said on-line game system notifies said user as predetermined incidents occur by means of an e-mail, a mobile phone, a telephone or a Internet phone.

13. The method as set forth in claim 9, wherein said user pays by a credit card, money remittance or game points.

14. The method as set forth in claim 9, wherein all properties or experience values of said first user is inherited by a third character appointed by said first user as said first character passes away in said virtual space.

15. A system for shopping in an on-line game, which comprises:
an on-line game server coupled to a network, for providing an on-line game platform and an on-line shopping platform, wherein a virtual. space is built by said on-line game platform and a virtual commodity in said virtual space emulates an article;
a first user terminal coupled to said on-line game server via said network, wherein said first user terminal plays said on-line game by manipulating a first virtual character in said virtual space; and
a logistics terminal coupled to said on-line game server, wherein said logistics terminal delivers said article to a receiver appointed by said first user as said article is purchased by said first user through said shopping platform.

16. The system as set forth in claim 15, wherein said first user appoints a second virtual character in said virtual space as said receiver, and said second virtual character is manipulated by a second user.

17. The system as set forth in claim 15, wherein time of said virtual space elapses continuously, and said first character keeps living in said virtual space after said first user logouts.

18. The system as set forth in claim 15, wherein a notification module storing of said on-line game server notifies said user as predetermined incidents occur by means of an e-mail, a mobile phone, a telephone or a Internet phone.

19. The system as set forth in claim 15, wherein said user pays by a credit card, money remittance or game points.

20. The system as set forth in claim 15, wherein all properties or experience values of said first user is inherited by a third character appointed by said first user as said first character passes away in said virtual space.
